(19) United States
(12) Patent Application Publication
(10) Pub. No.: US 2002/0050057 A1
(43) Pub. Date: May 2, 2002

(54) Process for the production of transposed conductors

(75) Inventor: Joachim Spichal, Volkmarsen (DE)

Correspondence Address: SUGHRUE MION ZINN MACPEAK & SEAS, PLLC, 2100 Pennsylvania Avenue, NW, Washington, DC, 20037-3213, US

(73) Assignee: Nexans

(21) Appl. No.: 09/870,787

(22) Filed: Jun. 1, 2001

(30) Foreign Application Priority Data
Jun. 2, 2000 (DE) 100 27 564.8

(51) Int. Cl. H01R 43/00

(52) U.S. Cl. 29/825

(57) ABSTRACT

A process for the production of transposed conductors (1) through the transposition of shaped wires (1a) with a rectangular cross-section, with a guide for the shaped wires (1a), which are supplied in two parallel stacks (1b, 1c), in which the shaped conductors (1a) currently lying lowermost and uppermost are displaced onto the neighboring stack (1b, 1c) while being provided with an offset, and one stack (1b) is pushed upward and the other stack (1c) is pushed downward, wherein he displacement of the shaped conductors (1a) and the pushing of the stacks (1b, 1c) is performed by servo motors (2).

This application is based on and claims the benefit of German Patent Application No. 10027564.8 filed Jun. 2, 2000, which is incorporated by reference herein.

### BACKGROUND OF THE INVENTION

The invention concerns a process and apparatus for the production of transposed conductors.

A device for the production of a composite electrical conductor is known, e.g., from GB-PS 969 086, in which the insulated individual conductors, which have a rectangular cross-section, pass through a Roebel transposition tool in stacks lying in parallel to one another. At the perimeter of the strand formed by the stacked shaped wires, sliders engage which displace the shaped conductor currently lying uppermost and/or lowermost onto the neighboring stack while providing the conductor with an offset. This process, which makes twisting of angular shaped conductors possible, is called Roebel transposition after the inventor Roebel, and the tool is called a Roebel transposition tool.

In addition to the two sliders for displacement of the upper and lower shaped wires onto the neighboring stack, the Roebel transposition tool also has two pushers which each push a stack of the individual conductors upwards or downwards, respectively. After completion of this pushing process, the sliders engage to displace the shaped wires in the way indicated.

In this known device, the offset length, i.e., the length from the beginning to the end of an offset, is relatively large. The winding properties, particularly for transposed conductors with a large number of shaped wires, are adversely affected.

The operation of the tool elements occurs through cams and eccentrics whose synchronization is ensured by a gear ring.

In order to keep the offset length, and thereby the length of lay and step of the transposed conductors, as short as possible during the twisting and/or transposition of shaped conductors with an angular cross-section, and to thereby improve the windability of the transposed conductors, a device is known (e.g., disclosed in DE-A-39 23 448) in which each slider is provided with a dolly, on the opposite side of the transposed conductor, which is journaled so that it is staggered relative to the slider in the direction of travel of the transposed conductor and can be displaced transversely to the transposed conductor opposite to the slider and is driven in synchronization with the movement of the slider and the pusher. The slider, the dolly, and the pusher are set in motion through hydraulic or pneumatic drives which are electronically controlled.

### SUMMARY OF THE INVENTION

It is an object of the present invention to improve the cycle time of the tools, and thereby the production speed.

This object is achieved by controlling the displacement of the shaped conductors and the pushing of the stacks by servo motors.

The tools can therefore be positioned significantly more exactly according to the teaching of the invention. The set-up times necessary if a transposed conductor with other dimensions is to be produced are significantly shorter, because instead of the adjustments of the tools, only the stroke and/or the speed of the servo motors has to be changed. These changes can be performed by stored programs.

A further significant advantage is obvious in that henceforth, transposed conductors with very small dimensions can also be produced.

Further features and advantages of the invention will become clear from the detailed description and claims below.

### BRIEF DESCRIPTION OF THE DRAWINGS

The invention is described in more detail with reference to the exemplary embodiments schematically depicted in the accompanying figures, where:

FIG. 1 shows a view of a Roebel head in the direction of manufacture of the Roebel bar and/or transposed conductor 1; and

FIGS. 2 and 3 are schematic illustrations of the servo motors coupled to the tools through screw drives.

### DETAILED DESCRIPTION OF THE INVENTION

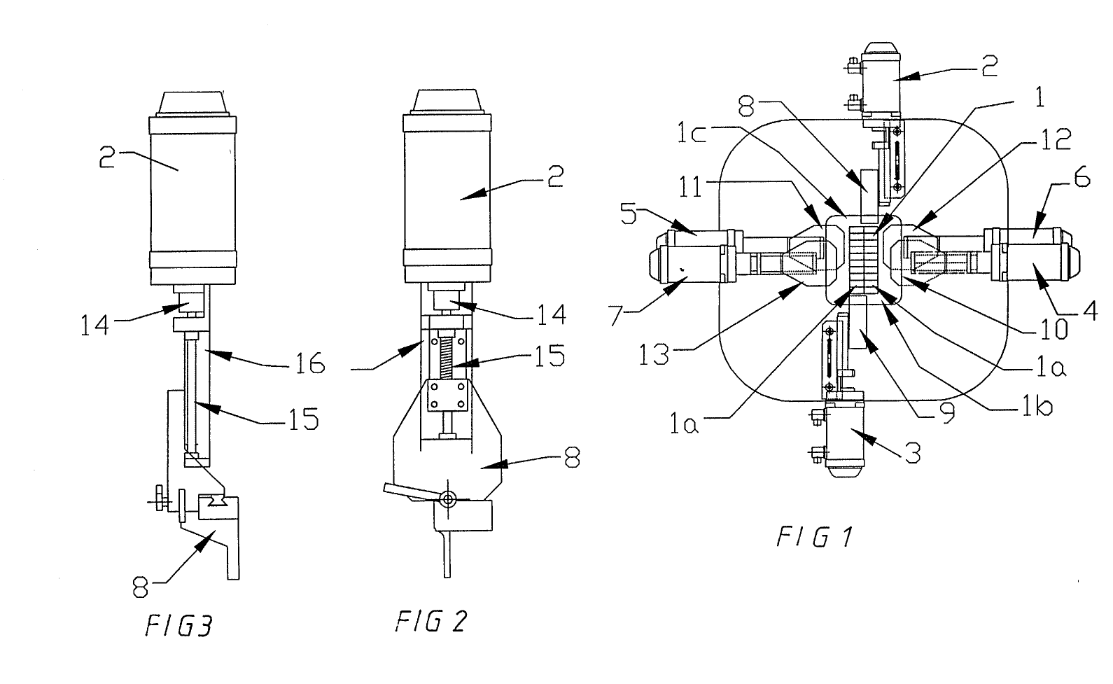

FIG. 1 shows a view of a Roebel head in the direction of manufacture of the Roebel bar and/or transposed conductor 1. For the sake of simplicity, the remainder of the description herein will be in the context of a transposed conductor. The transposed conductor 1 comprises a number of conductor elements 1a, which are divided into two stacks 1b and 1c. To transpose the conductor element 1a, the stack 1c is displaced upward and the stack 1b is displaced downward. Simultaneously, the lowermost conductor element 1a of the stack 1b in FIG. 1 is displaced onto the stack 1c and the uppermost conductor element 1a of the stack 1c is displaced onto the stack 1b. This process is known, and can be performed with either an even or odd number of conductor elements 1a.

According to the invention, the stacks 1b and 1c are pushed by the servo motors 2 and 3. The displacement of the conductor element 1a onto the neighboring stacks 1b and 1c is performed by the servo motors 4 and 5. In order to achieve a short offset length of the conductor element 1a, two further servo motors 6 and 7 are provided which oppose the servo motors 4 and 5.

Each of the servo motors 2 to 7 drives a tool 8 to 13 acting on the transposed conductor 1, as described in more detail below.

Because the mechanism is the same for all drives, it will be described in more detail for exemplary purposes for the servo motor 2 and the tool 8 with reference to the FIGS. 2 and 3.

The rotor 14 of the servo motor 2 is attached to a spindle 15, which it drives around its longitudinal axis. The spindle 15 has, in a way that is known, a groove and/or elevation running in a spiral, and/or a spiral thread. The tool 8 has a boring, not described in more detail, whose inner surface is tailored to the course of the groove and/or the thread. The tool 8 is guided in a guide 16 and thus secured against torsion. In this way, a rotational movement is transformed into a translational movement as the spindle 15 rotates, i.e., the tool 8 is moved towards or away from the transposed conductor 1 depending on the rotational direction.

What is claimed is:

1. A process for the production of transposed conductors through the transposition of shaped wires having a rectangular cross-section, with a guide for the shaped wires, which are provided in two parallel stacks, said process comprising the steps of displacing the shaped conductors currently lying lowermost and uppermost onto the neighboring stack while being provided with an offset, and pushing one stack upward and the other stack downward, wherein the displacement of the shaped conductors and the pushing of the stacks is controlled by servo motors.

2. A process according to claim 1, wherein each servo motor drives a respective spindle, and the rotational movement of each spindle is converted into translational movement to displace said conductors or push said stacks.

3. A process according to claim 2, wherein each spindle comprises a screw.

4. A process according to claim 1, wherein each servo motor is computer-controlled.

5. A device for the production of transposed conductors through the transposition of shaped wires having a rectangular cross-section, with a guide for the shaped wires, which are provided in first and second parallel stacks, in which the shaped conductors currently lying lowermost and uppermost are displaced onto the neighboring stack while being provided with an offset using tools, and the first stack is pushed upward and the second stack is pushed downward, also using tools, said device comprising at least one servo motor as a drive for each tool.

6. A device according to claim 5, each servo includes a rotor coupled to a spindle, each tool includes a bore having a surface with a thread tailored to one of the spindles, and every tool is guided in a guide.

7. A device according to claim 6, wherein every tool has a ball screw.

8. A device according to claim 5, comprising a computer which controls the drive of the servo motors depending on parameters for the transposed conductor.
